(19) United States
(12) Patent Application Publication
(10) Pub. No.: US 2026/0275012 A1
(43) Pub. Date: Sep. 17, 2026

(54) PROPYLENE ETHYLENE RANDOM COPOLYMER

(71) Applicant: Basell Poliolefine Italia S.r.l., Milano (IT)

(72) Inventors: Michele Grazzi, Ferrara (IT); Marco Ciarafoni, Ferrara (IT); Alberto Nardin, Ferrara (IT); Davide Tartari, Ferrara (IT); Eleonora Ciaccia, Ferrara (IT)

(73) Assignee: Basell Poliolefine Italia S.r.l., Milano (IT)

(21) Appl. No.: 19/162,360

(22) PCT Filed: Feb. 27, 2024
(86) PCT No.: PCT/EP2024/054951

§ 371 Date: Sep. 4, 2025

(30) Foreign Application Priority Data
Mar. 7, 2023 (EP) 23160537.9

(51) Int. Cl. C08F 210/06; C08F 210/02; D04H 1/4291; D04H 3/007

(52) U.S. Cl. CPC C08F 210/06; C08F 210/02; D04H 1/4291; D04H 3/007; D10B 2321/02

(57) ABSTRACT

A random propylene ethylene copolymer having:
i) a xylene soluble fraction at 25° C. ranging from 10 wt % to 16 wt %, based upon the total weight of the random propylene ethylene copolymer;
ii) a melt flow rate, MFR, measured according to ISO 1133 at 230° C. with a load of 2.16 kg, ranging from 50.0 g/10 min to 80.0 g/10 min;
iii) an ethylene derived units content ranging from 4.7 wt % to 5.8 wt %, based upon the total weight of the random propylene ethylene copolymer;
iv) a crystallization temperature measured by DSC, ranging from 82° C. to 105° C.; and
v) C13 NMR sequences PEP ranging from 4.0 mol % to 5.8 mol %.

### FIELD OF THE INVENTION

In general, the present disclosure relates to the field of chemistry. More specifically, the present disclosure relates to polymer chemistry. In particular, the present disclosure relates to a propylene ethylene random copolymer.

### BACKGROUND OF THE INVENTION

In some instances, nonwoven webs or fabrics are used in products such as workwear, workwear materials, garments, disposable diapers, and other personal hygiene products, including pre-moistened wipes. Disposable absorbent garments include diapers, incontinence briefs, training pants, and feminine hygiene products. In some instances, nonwoven webs are selected for strength, softness, and abrasion resistance. In some instances, soft, strong, nonwoven components include top sheets and back sheets (as alternatively, referred to as outer covers).

### SUMMARY OF THE INVENTION

In a general embodiment, the present disclosure provides a random propylene ethylene copolymer having:
i) a xylene soluble fraction at 25° C. ranging from 10 wt % to 16 wt %, based upon the total weight of the random propylene ethylene copolymer;
ii) a melt flow rate, MFR, measured according to ISO 1133 at 230° C. with a load of 2.16 kg, ranging from 50.0 g/10 min to 80.0 g/10 min;
iii) an ethylene derived units content ranging from 4.7 wt % to 5.8 wt %, based upon the total weight of the random propylene ethylene copolymer;
iv) a crystallization temperature measured by DSC, ranging from 82° C. to 105° C.; and
v) C¹³ NMR sequences PEP ranging from 4.0 mol % to 5.8 mol %.

### DETAILED DESCRIPTION OF THE INVENTION

In some embodiments, the present disclosure provides a random propylene ethylene copolymer having:
i) a xylene soluble fraction at 25° C. ranging from 10 wt % to 16 wt %; alternatively from 11 wt % to 15 wt %; alternatively from 11.5 wt % to 14.5 wt, based upon the total weight of the random propylene ethylene copolymer;
ii) a melt flow rate, MFR, measured according to ISO 1133 at 230° C. with a load of 2.16 kg, ranging from 50.0 g/10 min to 80.0 g/10 min; alternatively from 52.0 g/10 min to 75.0 g/10 min; alternatively from 53.0 g/10 min to 73.0 g/10 min;
iii) an ethylene derived units content ranging from 4.8 wt % to 5.8 wt %; alternatively from 4.9 wt % to 5.7 wt %; alternatively from 5.0 wt % to 5.6 wt %, based upon the total weight of the random propylene ethylene copolymer;
iv) a crystallization temperature measured by DSC, ranging from 82° C. to 105° C.; alternatively from 84° C. to 100° C.; alternatively from 85° C. to 99° C.; and
v) C¹³ NMR sequences PEP ranging from 4.0 mol % to 5.8 mol %; alternatively from 4.2 mol % to 5.7 mol %; alternatively 4.5 mol % to 5.5 mol %.

As used herein, the term “copolymer” refers to polymers containing two kinds of comonomers. In some embodiments, the comonomers are propylene and ethylene.

In some embodiments and in the random propylene ethylene copolymer, a single melting point is present at the DSC thermogram measured according to ISO 11357-3, at scanning rate of 20 C/min.

In some embodiments and in the random propylene ethylene copolymer, the relative content of isolated to block ethylene sequences I(E) is higher than 70.1; wherein I(E) is calculated with the following relation:

$$I ( E ) = ( PEP / [ EEE + PEE + PEP ] ) \times 100 ;$$

wherein I(E) is the relative content of isolated to block ethylene sequences (%); PEP is the mol fraction of propylene/ethylene sequences; PEE is the mol fraction of propylene/ethylene sequences; EEE is the mol fraction of propylene/ethylene sequences; and the sequence concentrations being based on a statistical triad analysis of 13C-NMR data.

The I(E) is the relative content of isolated to block ethylene sequences (%). The I(E) is believed to be an indication of the randomness of the polymer. As used herein, the term “random” refers to a propylene ethylene copolymer having (IE) higher than 65%.

In some embodiments and in the propylene ethylene copolymer, the melting point, Tm, and the ethylene content wt % C2, fulfill the following relation:

$$Tm < - 5.8 C 2 + 16 7. ;$$

Alternatively, the relation is:

$$Tm < - 5.8 C 2 + 1662 .$$

In some embodiments and in the propylene ethylene copolymer, the 2, 1 insertion is not detectable at the ¹³C NMR spectra acquired on a Bruker AV-600 spectrometer equipped with cryoprobe, operating at 160.91 MHz.

In some embodiments, the random propylene ethylene copolymer does not contain a propylene homopolymer fraction.

In some embodiments, the propylene ethylene copolymer is obtained with a process being carried out in a reactor having two interconnected polymerization zones, a riser and a downcomer, wherein the growing polymer particles:
(a) flow through the first polymerization zone, the riser, under fast fluidization conditions in the presence of propylene and ethylene;
(b) leave the riser and enter the second polymerization zone, the downcomer, through which the growing polymer particles flow downward in a densified form in the presence of propylene and ethylene, wherein the concentration of ethylene in the downcomer is higher than in the riser; and
(c) leave the downcomer and are reintroduced into the riser, thereby establishing a circulation of polymer between the riser and the downcomer.

In the first polymerization zone (riser), fast fluidization conditions are established by feeding a gas mixture made from or containing one or more alpha-olefins at a velocity higher than the transport velocity of the polymer particles. In some embodiments, the velocity of the gas mixture is between 0.5 and 15 m/s, alternatively between 0.8 and 5 m/s. As used herein, the terms “transport velocity” and “fast fluidization conditions” are as defined in “D. Geldart, Gas Fluidisation Technology, page 155 et seq., J. Wiley & Sons Ltd., 1986”.

In the second polymerization zone (downcomer), the polymer particles flow under the action of gravity in a densified form, thereby achieving the high values of density of the solid (mass of polymer per volume of reactor) and approaching the bulk density of the polymer. As used herein, the term “densified form” of the polymer indicates that the ratio between the mass of polymer particles and the reactor volume is higher than 80% of the “poured bulk density” of the polymer. In the downcomer the polymer flows downward in a plug flow and small quantities, if any, of gas are entrained with the polymer particles.

In some embodiments, the recycle gas stream is withdrawn from a gas/solid separator placed downstream the riser, cooled by passage through an external heat exchanger and then recycled to the bottom of the riser. In some embodiments, the recycle gas stream is made from or containing the gaseous monomers, the inert polymerization components, and chain transfer agents. In some embodiments, the inert polymerization components include propane. In some embodiments, the chain transfer agents include hydrogen. In some embodiments, the composition of the barrier stream deriving from condensation, distillation, or both of the gas recycle stream is adjusted by feeding liquid make-up monomers and propane before the gas recycle stream's introduction into the upper part of downcomer.

In some embodiments and in both riser and downcomer, the temperature is between 60° C. and 120° C., while the pressure ranges from 5 to 40 bar.

In some embodiments, the process for preparing the random propylene ethylene copolymer is carried out in presence of a highly stereospecific heterogeneous Ziegler-Natta catalyst. In some embodiments, the Ziegler-Natta catalysts are made from or containing a solid catalyst component made from or containing at least one titanium compound having at least one titanium-halogen bond and at least an electron-donor compound (internal donor), both supported on magnesium chloride. In some embodiments, the Ziegler-Natta catalysts systems are further made from or containing an organo-aluminum compound as a co-catalyst and optionally an external electron-donor compound.

In some embodiments, the catalysts systems are as described in the European Patent Nos. EP45977, EP361494, EP728769, and EP 1272533 and Patent Cooperation Treaty Publication No. W000163261.

In some embodiments, the organo-aluminum compound is an alkyl-Al selected from the trialkyl aluminum compounds. In some embodiments, the trialkyl aluminum compound is selected from the group consisting of triethylaluminum, triisobutylaluminum, tri-n-butylaluminum, tri-n-hexylaluminum, and tri-n-octylaluminum. In some embodiments, the trialkylaluminum is mixed with alkylaluminum halides, alkylaluminum hydrides or alkylaluminum sesquichlorides such as AlEt₂Cl and Al₂Et₃Cl₃.

In some embodiments, the external electron-donor compounds are selected from the group consisting of silicon compounds, ethers, esters, amines, heterocyclic compounds, ketones and 1,3-diethers. In some embodiments, the ester is ethyl 4-ethoxybenzoate. In some embodiments, the external electron-donor compound is 2,2,6,6-tetramethyl piperidine. In some embodiments, the external donor compounds are silicon compounds of formula Rₐ⁵R_{b}⁶Si(OR⁷)_{c} where a and b are integer from 0 to 2, c is an integer from 1 to 3 and the sum (a+b+c) is 4; R⁵, R⁶, and R⁷, are alkyl, cycloalkyl or aryl radicals with 1-18 carbon atoms optionally containing heteroatoms. In some embodiments, the silicon compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1, trifluoropropyl-2-ethylpiperidinyl-dimethoxysilane and 1,1,1, trifluoropropyl-methyldimethoxysilane. In some embodiments, the external electron donor compound is used in an amount to give a molar ratio between the organo-aluminum compound and the electron donor compound of from 0.1 to 500; alternatively from 1 to 100; alternatively from 2 to 50.

In some embodiments, the propylene ethylene copolymer compositions are further made from or containing additives, \peroxides, or both, thereby achieving a certain Melt Flow Rate.

In some embodiments, the additives are selected from the group consisting of pigments, opacifiers, fillers, stabilizers, flame retardants, antacids and whiteners.

In some embodiments, fibers are made from or containing the random propylene ethylene copolymer. In some embodiments, the fibers are prepared by melt-spinning the polyolefin composition. In some embodiments, the resulting fibers are single or composite fibers or filaments.

In some embodiments, the fibers are stable fibers or spunbond fibers.

In some embodiments and to prepare spunbond fibers, the random propylene ethylene copolymer is to visbreaking, thereby achieving a certain melt flow rate (MFR). In some embodiments, the visbreaking, or controlled chemical degradation, is carried out by treating the precursor polypropylene with an amount, alternatively from 0.001 to 0.20 wt %, alternatively from 0.05 to 0.1 wt %, of free radical initiators. In some embodiments, the chemical degradation is carried out by contacting, under high shear conditions, the polymeric material with at least one free radical initiator at a temperature equal to or higher than the decomposition temperature of the free radical initiator. In some embodiments, the free radical initiators are peroxides having a decomposition temperature higher than 250° C., alternatively ranging from 150° to 250° C. In some embodiments, the peroxides are selected from the group consisting of di-tert-butyl peroxide, dicumyl peroxide, 2,5-dimethyl-2,5-di(tert-butylperoxy) hexyne, and 2,5-dimethyl-2,5-di(tert-butylperoxy) hexane. In some embodiments, the peroxides are commercially available from Akzo or Arkema under the name Trigonox 101 or Luperox 101, respectively.

In some embodiments, the fibers are further made from or containing additives. In some embodiments, the additives are selected from the group consisting of antioxidants, light stabilizers, heat stabilizers, nucleating agents, colorants and fillers.

In some embodiments, the fibers exhibit a value of tenacity at least equal to or higher than 20.0 cN/tex and lower than 30.0 cN/tex, alternatively higher than 24.5 cN/tex, alternatively higher than 26.5 cN/tex.

In some embodiments, the fibers according have a titer ranging from 1 to 8 dtex, alternatively from 1.5 to 4.0 dtex.

In some embodiments, the fibers are spun at temperatures varying from 200° to 300° C., alternatively lower than 250° C., alternatively between 220° and 250° C.

In some embodiments, non-woven fabrics are made from or containing the fibers.

In some embodiments, the non-woven fabrics are produced with various methods, alternatively spunbonding. In some embodiments, the spunbonding process is a non-woven manufacturing technique, whereby polymers are directly converted into endless filaments and stochastically deposited to form a non-woven material.

In some embodiments, the fibers have a diameter of 10 to 50 micrometers.

In some embodiments, fibers are spread to form directly a fiber web and calendered, thereby obtaining a non-woven fabric.

In some embodiments and in a spunbonding process, the polymer is heated in an extruder to the melting point of the polyolefin composition and then the molten polyolefin composition is pumped under pressure through a spinneret containing a number of orifices of a specified diameter, thereby producing filaments of the molten polymer composition and without subjecting the filaments to a subsequent drawing.

In some embodiments, the equipment includes an extruder with a die on the extruder's spinning head, a cooling tower, and an air suction gathering device that uses Venturi tubes.

In some embodiments and underneath this device that uses air speed to control the filaments speed, the filaments are gathered over a conveyor belt, where the filaments are distributed to form a web.

In some embodiments and using spunbond machinery, the process conditions include:
output per hole ranging from 0.3-0.8 g/min, alternatively from 0.4-0.6 g/min;
cooling molten polymer filaments fed from the face of the spinneret by air flow, thereby solidifying the filaments; and
spinning temperature between 200° and 300° C.

The filaments are then brought by the conveyor belt to the thermal bonding step, which is carried out by calendering through a couple of heated rolls.

In some embodiments and when using the fibers or filaments, the balance of mechanical properties is achieved at low thermal bonding temperatures, alternatively from 120° C. to 170° C.

The following examples are given to illustrate, not to limit, the present disclosure:

### EXAMPLES

### Xylene-Soluble (XS) Fraction at 25° C.

Xylene Solubles at 25° C. was determined according to ISO 16 152; with solution volume of 250 ml, precipitation at 25° C. for 20 minutes, including 10 minutes with the solution in agitation (magnetic stirrer), and drying at 70° C.

### DSC Method for Melting Temperature and Crystallization Temperature

Melting point was measured according to ISO 11357-3, at scanning rate of 20 C/min both in cooling and heating, on a sample of weight between 5 and 7 mg., under inert N2 flow. The instrument was calibrated with indium.

### Melt Flow Rate (MFR)

Measured according to ISO 1133 at 230° C. with a load of 2.16 kg, unless otherwise specified.

### Ethylene Content in the Copolymers

¹³C NMR spectra were acquired on a Bruker AV-600 spectrometer equipped with cryoprobe, operating at 160.91 MHz in the Fourier transform mode at 120° C.

The peak of the SBB carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as an internal standard at 29.9 ppm. The samples were dissolved in 1,1,2,2-tetrachloroethane-d2 at 120° C. with an 8% wt/v concentration. Each spectrum was acquired with a 90° pulse, and 15 seconds of delay between pulses and CPD, thereby removing ¹H-¹³C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with 8-titanium trichloride-diethyl-aluminum chloride” M. Kakugo, Y. Naito, K. Mizunuma and T. Miyatake, Macromolecules, 1982, 15, 1150) using the following equations:

$$PPP = 100 T ββ / S PPE = 100 T β δ / S EPE = 100 T δδ / S$$

$$PEP = 100 S β β / S PEE = 100 S β δ / S EEE = 100 ( 0.25 S γ δ + 0.5 S δδ ) / S$$

$$S = T ββ + T β δ + T δδ + S ββ + S β δ + 0.25 S γδ + 0.5 S δ δ$$

The molar percentage of ethylene content was evaluated using the following equation:

$$E \% mol = 100 * [ PEP + PEE + EEE ] .$$

The weight percentage of ethylene content was evaluated using the following equation:

$$100 * E \% mol * MWE$$

$$E \% wt . = E \% mol * MWE + P \% mol * MWP$$

where P % mol is the molar percentage of propylene content, while MWE and MWP are the molecular weights of ethylene and propylene, respectively.

The content of isolated to block ethylene sequences I(E) was calculated with the following relation:

$$I ( E ) = ( PEP / [ EEE + PEE + PEP ] ) \times 100 ;$$

The product of reactivity ratio r1r2 was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of Propylene sequences was calculated as mm content from the ratio of the PPP mmT_{ββ} (28.90-29.65 ppm) and the whole Tββ (29.80-28.37 ppm).

### Determination of the Regioinvertions:

Determined by C¹³-NMR according to the methodology described by J. C. Randall in “Polymer sequence determination Carbon 13 NMR method”, Academic Press 1977. The content of regioinvertions was calculated on the basis of the relative concentration of S_{αβ}+S_{ββ} methylene sequences.

### Example 1

### Preparation of the Ziegler-Natta Solid Catalyst Component

The Ziegler-Natta catalyst was prepared as described for Example 5, lines 48-55, of European Patent No. EP728769B1.

### Preparation of the Catalyst System—Precontact

Before introducing the solid catalyst component into the polymerization reactors, the solid catalyst component was contacted with aluminum-triethyl (TEAL) and dicyclopentyldimethoxysilane (D donor) under the conditions reported in Table 1.

### Prepolymerization

The catalyst system was then subjected to prepolymerization treatment at 20° C. by maintaining the catalyst system in suspension in liquid propylene for a residence time of 9 minutes before introducing the catalyst system into the polymerization reactor.

### Polymerization

The polymerization was carried out in gas-phase polymerization reactor including two interconnected polymerization zones, a riser and a downcomer, as described in European Patent No. EP782587. Hydrogen was used as a molecular weight regulator. The polymer particles exiting from the polymerization step were subjected to a steam treatment, thereby removing the unreacted monomers, and dried under a nitrogen flow.

The main precontact, prepolymerization and polymerization conditions and the quantities of monomers and hydrogen fed to the polymerization reactor are reported in Table 1.

TABLE 1

| | | comp | | | | comp |
|---|---|---|---|---|---|---|
| | | ex 1 | ex 2 | ex 3 | ex 4 | ex 5 |
| PRECONTACT | | | | | | |
| Temperature | ° C. | 15 | 15 | 15 | 15 | 15 |
| Residence Time | min | 15-17 | 15-17 | 15-17 | 15-17 | 15-17 |
| TEAL/catalyst | wt/wt | 6 | 6 | 6 | 6 | 6 |
| TEAL/Ext. Donor | g/g | 4 | 4 | 4 | 4 | 4 |
| PREPOLYMERIZATION | | | | | | |
| Temperature | ° C. | 28-30 | 28-30 | 28-30 | 28-30 | 28-30 |
| Residence Time | min | 10-13 | 10-13 | 10-13 | 10-13 | 10-13 |
| POLYMERIZATION | | | | | | |
| Temperature | bar-g | 70 | 70 | 70 | 67 | 67 |
| Pressure | bar-g | 27 | 27 | 27 | 27 | 27 |
| Residence Time | min | 90-100 | 90-100 | 90-100 | 90-100 | 90-100 |
| Split holdup riser | wt % | 35-40 | 35-40 | 35-40 | 35-40 | 35-40 |
| Split holdup | wt % | 60-65 | 60-65 | 60-65 | 60-65 | 60-65 |
| downcomer | | | | | | |
| C₂⁻/C₂⁻ + C3⁻ | mol/mol | 0.039 | 0.043 | 0.034 | 0.039 | 0.046 |
| riser | | | | | | |
| C₂⁻/C₂⁻ + C3⁻ | mol/mol | (C2− feed | (C2− feed | (C2− feed | 0.037 | 0.037 |
| downcomer | | in riser, not | in riser, not | in riser, not | (C2− feed | (C2− feed |
| | | downcomer) | downcomer) | downcomer) | in both | in both |
| | | | | | riser and | riser and |
| | | | | | downcomer) | downcomer) |
| H₂/C₃⁻ riser | mol/mol | 0.0132 | 0.0160 | 0.0078 | 0.0170 | 0.0330 |
| H₂/C3⁻ | mol/mol | (H2 feed | (H2 feed | (H2 feed | 0.0090 | 0.0090 |
| downcomer | | in riser, not | in riser, not | in riser, not | (H2 feed | (H2 feed |
| | | downcomer) | downcomer). | downcomer) | in both | in both |
| | | | | | riser and | riser and |
| | | | | | downcomer) | downcomer) |

H2 = hydrogen;
C2− = ethylene,
C3− = propylene

The features of the polymers are reported in Table 2.

TABLE 2

| | | comp | | | | comp |
|---|---|---|---|---|---|---|
| | | ex 1 | ex 2 | ex 3 | ex 4 | ex 5 |
| Ethylene content | Wt % | 4.6 | 5.0 | 5.2 | 5.4 | 6.0 |
| Xylene soluble | Wt % | 8.2 | 10.5 | 11.0 | 13.0 | 16.3 |
| at 25° C. | | | | | | |
| MFR | g/10 min | 5.3 | 5.5 | 5.9 | 5.1 | 7.7 |
| PEP sequences | Mol % | — | 5.1 | 5.4 | 5.4 | 5.9 |
| I(E) | ° C. | 74.39 | 70.3 | 71.1 | 73.6 | 68.1 |
| melting point | ° C. | 139.9 | 136.6 | 133.7 | 132.9 | 131.2 |
| crystallization | ° C. | 97.7 | 92.6 | 90.1 | 87.5 | 86.2 |
| temperature | | | | | | |
| 2, 1 regioinsertion | % | nd | nd | nd | nd | nd |

Nd = not detectable

The products of Table 2 were visbroken. The features of the polymers were unchanged, except for the MFR as reported in Table 3.

TABLE 3

| | | comp | | | | comp |
|---|---|---|---|---|---|---|
| | | ex 1 | ex 2 | ex 3 | ex 4 | ex 5 |
| MFR | g/10 min | 60.1 | 72.7 | 77.5 | 67.4 | 77.5 |

### Preparation of the Fibers

The polymer materials were extruded. Then, the polymers were spun in a Leonard 25 spinning pilot line with screw L/D ratio of 25, screw diameter of 25 mm and compression ratio of 1:3. The line was commercially available from Costruzioni Meccaniche Leonard-Sumirago (VA). The operative spinning conditions were as follows.

### Operative Conditions:

Hole diameter: mm 0.6
Output per hole: g/min 0.6
Hole number in the die: 37
Die temperature (° C.): 250
Melt temperature (C): 258.

The mechanical properties of the fibers are reported in Table 4.

### Titer of Filaments

From a 10 cm long roving, 50 fibers were randomly chosen and weighed. The total weight of the 50 fibers, expressed in mg, was multiplied by 2, thereby obtaining the titer in dtex.

### Tenacity and Elongation at Break of Filaments

From a 500 m roving, a 100 mm-long segment was cut and single fibers randomly chosen. Each single fiber was fixed to the clamps of a Dynamometer and tensioned to break with a traction speed of 20 mm/min for elongations lower than 100% and 50 mm/min for elongations greater than 100%, the initial distance between the clamps being of 20 mm. The ultimate strength (load at break) and the elongation at break were determined in machine (MD) direction.

The tenacity was calculated by way of the following equation:

$$Tenacity = Ultimate strength ( cN ) \times 10 / Titer ( dtex )$$

### Maximum Spinning Speed

The maximum spinning speed corresponded to the highest spinning rate, which was maintained for 30 minutes with no filament break.

The mechanical properties of the fibers are reported in Table 4.

TABLE 4

| | | comp | | | | comp |
|---|---|---|---|---|---|---|
| | | ex 1 | ex 2 | ex 3 | ex 4 | ex 5 |
| Titer fiber | dTex | 2.3 | 2.3 | 2.3 | 2.3 | 2.3 |
| Tenacity | cN/Tex | 26.0 | 27.8 | 26.4 | 27.4 | 26.1 |
| Maximum | m/min | 4500 | 4500 | 4500 | 4500 | 4500 |
| spinning speed | | | | | | |

What is claimed is:

1. A random propylene ethylene copolymer having:
i) a xylene soluble fraction at 25° C. ranging from 10 wt % to 16 wt %, based upon the total weight of the random propylene ethylene copolymer;
ii) a melt flow rate, MFR, measured according to ISO 1133 at 230° C. with a load of 2.16 kg, ranging from 50.0 g/10 min to 80.0 g/10 min;
iii) an ethylene derived units content ranging from 4.7 wt % to 5.8 wt %, based upon the total weight of the random propylene ethylene copolymer;
iv) a crystallization temperature measured by DSC, ranging from 82° C. to 105° C.; and
v) the C¹³ NMR sequences PEP ranging from 4.0 mol % to 5.8 mol %.

2. The random propylene ethylene copolymer according to claim 1, wherein a single melting point is present at the DSC thermogram measured according to ISO 11357-3, at scanning rate of 20° C./min.

3. The random propylene ethylene copolymer according to claim 1, wherein the melt flow rate, MFR, measured according to ISO 1133 at 230° C. with a load of 2.16 kg, ranges from 52.0 g/10 min to 75.0 g/10 min.

4. The random propylene ethylene copolymer according to claim 1, wherein the ethylene derived units content ranges from 4.9 wt % to 5.7 wt %, based upon the total weight of the random propylene ethylene copolymer.

5. The random propylene ethylene copolymer according to claim 1, wherein the crystallization temperature measured by DSC, ranges from 84° C. to 100° C.

6. The random propylene ethylene copolymer according to claim 1, wherein the C¹³ NMR sequences PEP ranges from 4.2 mol % to 5.7 mol %.

7. The random propylene ethylene copolymer according to claim 1, wherein the relative content of isolated to block ethylene sequences I(E) is higher than 70.1; wherein I(E) is calculated with the following relation
$$I ( E ) = ( PEP / [ EEE + PEE + PEP ] ) \times 100 ;$$
wherein I(E) is the relative content of isolated to block ethylene sequences (%); PEP is the mol fraction of propylene/ethylene sequences; PEE is the mol fraction of propylene/ethylene sequences; EEE is the mol fraction of propylene/ethylene sequences; and the sequence concentrations being based on a statistical triad analysis of ¹³C-NMR data.

8. The random propylene ethylene copolymer according to claim 1, wherein the melting point, Tm, and the ethylene content wt %, C2, fulfill the following relation:
$$Tm < - 5.8 C 2 + 167. .$$

9. The random propylene ethylene copolymer according to claim 1, wherein the 2, 1 insertion is not detectable at the ¹³C NMR spectra acquired on a Bruker AV-600 spectrometer equipped with cryoprobe, operating at 160.91 MHz.

10. The random propylene ethylene copolymer according to claim 1, wherein the xylene soluble fraction at 25° C. ranges from 11 wt % to 15 wt %, based upon the total weight of the random propylene ethylene copolymer.

11. The random propylene ethylene copolymer according to claim 1, wherein the melt flow rate, MFR, measured according to ISO 1133 at 230° C. with a load of 2.16 kg, ranges from 53.0 g/10 min to 73.0 g/10 min.

12. The random propylene ethylene copolymer according to claim 1, wherein the ethylene derived units content ranges from 5.0 wt % to 5.6 wt %, based upon the total weight of the random propylene ethylene copolymer.

13. The random propylene ethylene copolymer according to claim 1, wherein the crystallization temperature measured by DSC ranges from 85° C. to 99° C.

14. A fiber comprising the random propylene ethylene copolymer according to claim 1.

15. Non-woven fabrics comprising the fiber of claim 14.
